(19) United States
(12) Patent Application Publication
(10) Pub. No.: US 2008/0129895 A1
(43) Pub. Date: Jun. 5, 2008

(54) Controller IC and liquid crystal television mounting the same

(76) Inventor: Yutaka Jikumaru, Osaka (JP)

Correspondence Address: Jonathan P. Osha;Osha Novak & May L.L.P., Suite 2800, 1221McKinney St., Houston, TX, 77010, US

(21) Appl. No.: 10/850,311

(22) Filed: May 20, 2004

(30) Foreign Application Priority Data
May 22, 2003 (JP) P 2003-144306

(51) Int. Cl. H04N 3/14; H04N 5/66

(52) U.S. Cl. 348/790; 348/E05.096

(57) ABSTRACT

In a controller IC in which a decoder for decoding a video signal from a tuner and a controller for controlling a liquid crystal display section for displaying video of a video signal decoded are incorporated into a one-chip semiconductor, a signal selection section is provided between the decoder and the controller. The signal selection section switches a video signal a decoded by the decoder and a test pattern signal inputted from a pattern generator in response to a mode switching signal, and selects the video signal in a normal mode and the test pattern signal in a test mode. The controller displays predetermined pattern video on the liquid crystal display section based on the test pattern signal selected by the signal selection section in the test mode.

### BACKGROUND OF THE INVENTION

1. Field of the Invention

The present invention relates to a controller IC used in a liquid crystal television etc.

2. Description of the Related Art

FIG. 3 shows a schematic block diagram of a conventional liquid crystal television. Numeral 50 is a liquid crystal television, and includes a tuner 51, a decoder 54, a controller 55 and a liquid crystal display section 53. The decoder 54 decodes a video signal and a controller 55 controls the liquid crystal display section 53. A liquid crystal module 52 includes the controller 55 and liquid crystal display section 53. Numeral 56 is an antenna for receiving broadcast waves.

A channel of a signal received by the antenna 56 is selected by the tuner 51 and a predetermined video signal is inputted to the decoder 54. The decoder 54 performs processing for converting the inputted video signal into a digital signal. Also, similar processing is performed with respect to a video signal inputted from the outside. A video signal converted into the digital signal is given to the controller 55. In the controller 55, a driving signal for displaying video based on the video signal from the decoder 54 on the liquid crystal display section 53 is generated and this driving signal is outputted to the liquid crystal display section 53. In the liquid crystal display section 53, based on the driving signal from the controller 55, a liquid crystal cell is driven and predetermined video is displayed.

In the following JP-A-54-44497 and JP-A-3-237428, techniques about inspection in a liquid crystal display apparatus are disclosed. In JP-A-54-44497, an inspection circuit for inspecting driving capability of a liquid crystal driving circuit is described and in JP-A-3-237428, a circuit for inspecting a leakage current of a switch circuit for switching a power source input is described. Also, a technique for displaying a previously built-in predetermined pattern on a screen in order to prevent display of a disturbed image in case that an irregular signal is inputted is disclosed in JP-A-10-319916.

In the liquid crystal television 50 shown in FIG. 3, when video of a video signal received by the tuner 51 is not displayed normally on the liquid crystal display section 53, abnormality possibly occurs in the decoder 54 or the controller 55. However, there is a problem that it cannot be determined whether the decoder 54 or the controller 55 is defective. With respect to this problem, an effective solution is not shown in any of JP-A-54-44497, JP-A-3-237428, and JP-A-10-319916.

### SUMMARY OF THE INVENTION

The invention is implemented to solve the problem, and an object of the invention is to provide a controller IC capable of easily identifying a defective point.

In the invention, in a controller IC for video equipment, including a decoder for decoding a video signal and a controller for controlling a display section for displaying video based on a video signal decoded by this decoder, the decoder and the controller being incorporated into a one-chip semiconductor, a signal selection section is provided between the decoder and the controller. This signal selection section has a function of switching a video signal and a test signal inputted from the outside, and the controller displays predetermined video on the display section based on the test signal selected by the signal selection section.

In case that video of a video signal is not displayed normally on the display section and a defect possibly occurs in the controller IC, a test signal is inputted to the controller IC from the outside and video (such as a test pattern) based on the test signal is displayed on the display section. When this video is displayed normally, it can be determined that abnormality does not occur in the controller and occurs in the decoder. On the other hand, when the video based on the test signal is not displayed normally, it can be determined that abnormality occurs in the controller. Thus, by providing the signal selection section and checking video by the test signal, a defective point of a chip can be identified.

In a typical embodiment, the controller IC of the invention is mounted in a liquid crystal television, and a signal selection section has a function of switching a video signal decoded by a decoder and a test pattern signal inputted from a pattern generator of the outside in response to a mode switching signal and respectively selects the video signal in a normal mode and the test pattern signal in a test mode. Also, a controller displays predetermined pattern video on a liquid crystal display section based on the test pattern signal selected by the signal selection section in the test mode. According to this, by connecting the pattern generator, a test can be made simply using various test patterns.

Further, since the decoder and the controller being incorporated into a one-chip semiconductor, the minimization and the cost-down of the equipment can be realized, and the breaking of the signal line is prevented.

### BRIEF DESCRIPTION OF THE DRAWINGS

These and other objects and advantages of this invention will become more fully apparent from the following detailed description taken with the accompanying drawings in which:

FIG. 1 is a block diagram showing an embodiment of a controller IC according to the invention and a liquid crystal television mounting the controller IC;

FIG. 2 is a diagram showing one example of a specific configuration of a signal selection section; and

FIG. 3 is a schematic block diagram of a conventional liquid crystal television.

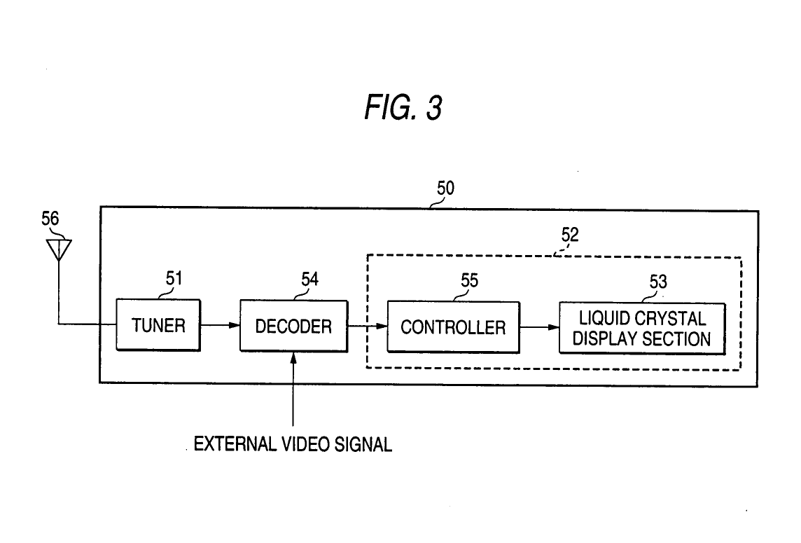

### DETAILED DESCRIPTION OF THE PREFERRED EMBODIMENTS

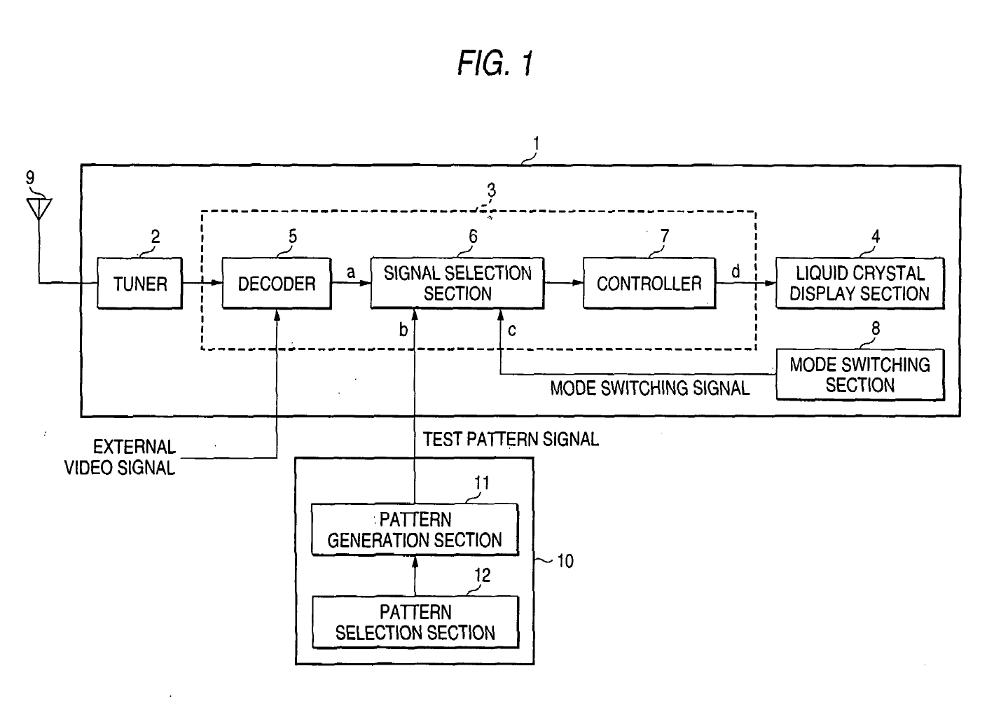

FIG. 1 is a block diagram showing an embodiment of a controller IC according to the invention and a liquid crystal television mounting the controller IC. Incidentally, only blocks related to the invention are illustrated herein. Numeral 1 is a liquid crystal television, and includes a tuner 2, a controller IC 3 for processing a video signal from this tuner 2 or a video signal inputted from the outside, and a liquid crystal display section 4 for displaying video based on the video signal processed by this controller IC 3.

The controller IC 3 includes a decoder 5 for decoding a video signal, a signal selection section 6 having a function of switching a video signal from the decoder 5 and a test pattern signal inputted from the outside, and a controller 7 for controlling the liquid crystal display section 4, and is constructed by incorporating these decoder 5, the signal selection section 6 and the controller 7 into a one-chip semiconductor. Numeral 8 is a mode switching section for switching a normal mode and a test mode, and is constructed of, for example, a DIP switch. Numeral 9 is an antenna for receiving broadcast waves.

Numeral 10 is a pattern generator for generating a test pattern signal, and includes a pattern generation section 11 for generating a test pattern and a pattern selection section 12 for selecting a predetermined pattern from among plural test patterns. The test pattern includes, for example, a color bar or a lattice pattern. A test pattern signal b outputted from the pattern generator 10 includes a clock signal and a data signal, and the respective signals are inputted to the signal selection section 6 of the controller IC 3 as a serial signal.

Next, an action will be described. When a normal mode is selected by the mode switching section 8, a channel of a signal received by the antenna 9 is selected by the tuner 2 and a predetermined video signal is inputted to the controller IC 3. The decoder 5 of the controller IC 3 performs processing etc. for converting the inputted video signal into a digital signal. Also, similar processing is performed with respect to a video signal inputted from the outside. In the normal mode, in response to a mode switching signal c, the signal selection section 6 does not select a test pattern signal and selects a video signal, so that a video signal a converted into a digital signal by the decoder 5 passes through the signal selection section 6 and is given to the controller 7. In the controller 7, a driving signal d for displaying video based on the video signal a from the decoder 5 on the liquid crystal display section 4 is generated and this driving signal is outputted to the liquid crystal display section 4. In the liquid crystal display section 4, based on the driving signal d from the controller 7, a liquid crystal cell is driven and predetermined video is displayed.

In case that video of a video signal is not displayed normally on the liquid crystal display section 4 and a defect possibly occurs in the controller IC 3, a test mode is selected by the mode switching section 8 and also the pattern generator 10 is connected to a terminal for test of the controller IC 3 through a cable. Then, a predetermined pattern is selected by the pattern selection section 12 and the selected pattern is generated by the pattern generation section 11. In a test mode, in response to a mode switching signal c, the signal selection section 6 does not select a video signal a and selects a test pattern signal b, so that the test pattern signal b serially inputted from the pattern generator 10 passes through the signal selection section 6 and is given to the controller 7. In the controller 7, a driving signal d for displaying video based on the test pattern signal b on the liquid crystal display section 4 is generated and this driving signal is outputted to the liquid crystal display section 4. In the liquid crystal display section 4, based on the driving signal d from the controller 7, a liquid crystal cell is driven and predetermined pattern video is displayed.

Here, in the case of selecting, for example, a lattice pattern in the pattern generator 10, it can be determined that abnormality does not occur in the controller 7 and occurs in the decoder 5 when video of the lattice pattern is displayed normally on the liquid crystal display section 4. On the other hand, it can be determined that abnormality occurs in the controller 7 when video of the lattice pattern is not displayed normally on the liquid crystal display section 4 and, for example, a distorted pattern is displayed or nothing is displayed on a screen or disturbed video is displayed.

Thus, in the embodiment described above, it is constructed so that the signal selection section 6 is provided in the controller IC 3 and at the time of a test mode, a test pattern signal b is selected to display a test pattern on the liquid crystal display section 4, so that by visually checking whether or not displayed video matches with video of the selected test pattern, abnormality of the decoder 5 and the controller 7 can be distinguished and diagnosed and a defective point of a chip can be identified. Also, by connecting the pattern generator 10 through a cable, a test can be made simply using various test patterns.

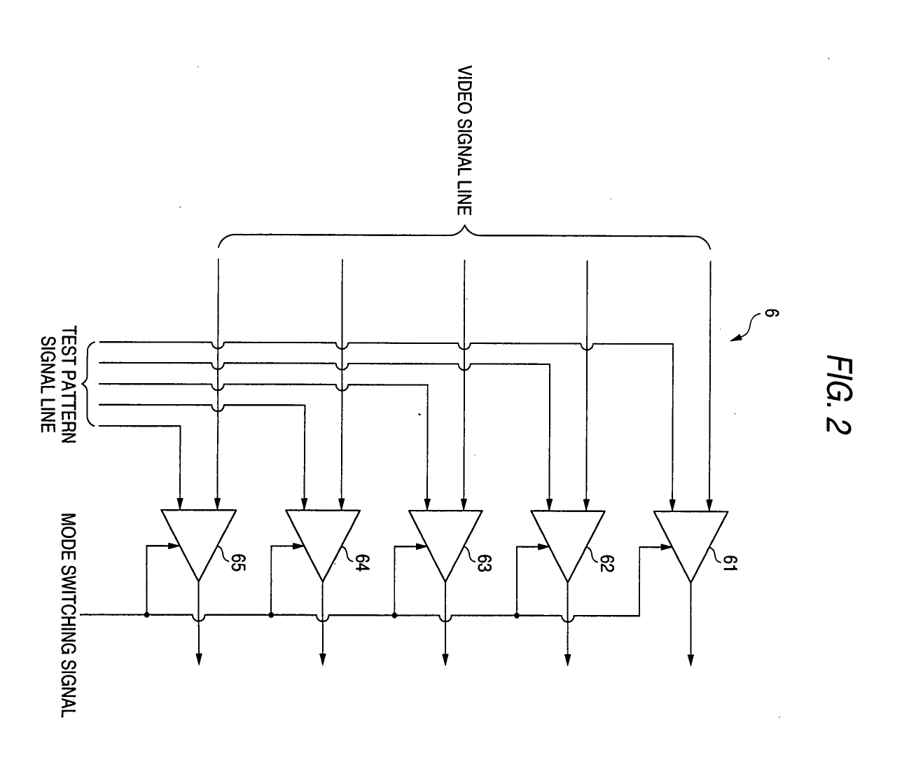

FIG. 2 is a diagram showing one example of a specific configuration of the signal selection section 6. Numerals 61 to 65 are signal switching circuits, and each line of a video signal from the decoder 5, each line of a test pattern signal from the pattern generator 10 and a mode switching signal from the mode switching section 8 are inputted. Any of the signal switching circuits 61 to 65 include logic circuits, and are constructed so that a video signal respectively inputted from each the line of the video signal is outputted when a mode switching signal is a signal indicating a normal mode and a test pattern signal respectively inputted from each the line of the test pattern signal is outputted when a mode switching signal is a signal indicating a test mode.

In the embodiment described above, it has been constructed so that the mode switching section 8 is provided and a test mode is manually set in this mode switching section 8, but it may be constructed so that a test mode is automatically set at the time of connecting the pattern generator 10 to a terminal for test of the controller IC 3 through a cable. Also, in the embodiment, it has been constructed so as to display pattern video on the liquid crystal display section 4 using a test pattern signal, but it may be constructed so as to display any video based on a test signal without being limited to a pattern. Also, as described in the embodiment, there is an advantage capable of decreasing the number of lines of a signal by serially inputting the test pattern signal b to the controller IC 3, but in the invention, the test pattern signal is not necessarily inputted serially and may be inputted in parallel. Further, in the embodiment, a liquid crystal television has been taken as an example, but the invention can also be applied to video equipment other than the liquid crystal television.

According to the invention, it is constructed so that a signal selection section is provided in a controller IC and video by a test signal is displayed on a display section, so that by checking this video, abnormality of a decoder and a controller can be distinguished and a defective point of the controller IC can be identified in inspection.

What is claimed is:

1. A controller IC for liquid crystal television comprising:
a decoder for decoding a video signal from a tuner;
a controller for controlling a liquid crystal display section for displaying video based on a video signal decoded by the decoder; and
a signal selection section, wherein:
the decoder and the controller being incorporated into a one-chip semiconductor;
the signal selection section is provided between the decoder and the controller of the controller IC;
the signal selection section has a function of switching a video signal decoded by the decoder and a test pattern signal inputted from a pattern generator of the outside in response to a mode switching signal from a mode switching section and respectively selects the video signal in a normal mode and the test pattern signal in a test mode; and
the controller displays predetermined pattern video on the liquid crystal display section based on the test pattern signal selected by the signal selection section in the test mode.

2. A controller IC for video equipment, comprising:
a decoder for decoding a video signal;
a controller for controlling a display section for displaying video based on a video signal decoded by the decoder; and
a signal selection section, wherein:
the decoder and the controller being incorporated into a one-chip semiconductor;
the signal selection section is provided between the decoder and the controller of the controller IC;
the signal selection section has a function of switching a video signal and a test signal inputted from the outside; and
the controller displays predetermined video on the display section based on the test signal selected by the signal selection section.

3. A liquid crystal television comprising:
a tuner;
a controller IC for processing a video signal from the tuner; and
a liquid crystal display section for displaying video based on a video signal processed by this controller IC, wherein:
the controller IC being constructed of a one-chip semiconductor into which a decoder for decoding a video signal from the tuner and a controller for controlling the liquid crystal display section are incorporated;
a signal selection section is provided between the decoder and the controller of the controller IC;
the signal selection section has a function of switching a video signal decoded by the decoder and a test pattern signal inputted from a pattern generator of the outside in response to a mode switching signal and respectively selects the video signal in a normal mode and the test pattern signal in a test mode; and
the controller displays predetermined pattern video on the liquid crystal display section based on the test pattern signal selected by the signal selection section in the test mode.
